(19) United States
(12) Patent Application Publication
(10) Pub. No.: US 2014/0028994 A1
(43) Pub. Date: Jan. 30, 2014

(54) Far-Optical Device With Control Electronics

(71) Applicant: Swarovski-Optik KG., Absam (AT)

(72) Inventor: Sandra Wechselberger, Weer (AT)

(21) Appl. No.: 13/916,706

(22) Filed: Jun. 13, 2013

(30) Foreign Application Priority Data
Jun. 14, 2012 (AT) A 687/2012

(51) Int. Cl. G02B 23/00

(52) U.S. Cl. CPC G02B 23/00
USPC 356/3; 359/399

(57) ABSTRACT

The present application describes a far-optical device having a basic body, at least one electrical load, and control electronics for controlling the electrical load. The control electronics being integrated in a detachable unit that is capable of being attached to and detached from the basic body of the far-optical device. When detachable unit is detached from the basic body, the control electronics can be programmed by the user via at least one operating element disposed on the detachable unit. This provides the user with the means to modify, restore, or extend the existing functions of the far-optical device. Thus, the far-optical device of the current application provides for a far-optical device with a high-level of user-friendliness.

The invention relates to a far-optical device, in particular a telescope, a sight or a sighting telescope according to the preamble of patent claim 1 and a detachable unit for a far-optical device.

Far-optical devices such as telescopes, sights or sighting telescopes are increasingly equipped with functionalities to continue to extend or improve the operation of the far-optical device for the user and the fields of application of the performance characteristics of such a device. The functional components allowing such extended functionality frequently require a control electronics controlling electrical loads such as for example a reticule illumination or an ambient lighting of a sighting telescope. In order to activate or influence the function of such a load, one or several operating elements are usually required, by means of which the user is able to influence the function transferred by the electrical load, which therefore represents a function of the far-optical device. A number of approaches have been known from prior art in this respect.

Document AT 504 242 B1 discloses a far-optical device, in particular a sighting telescope, having a switching element, operating between an energy source and an electrical load, for activating or setting a function caused by the electrical load of the far-optical device by a user. A motion element is moveably mounted to the far-optical device, in particular to an eyepiece section. This being the case, the switching element is arranged on the motion element. In one embodiment, the motion element is detachably connected to the far-optical device by means of a snap-connection. With its switching elements and, if applicable, an information device, the motion element only represents an operating interface for the user, it does however not contain any further functions. In a detached state, the motion element has no functionalities.

For controlling a reticule illumination of a sighting telescope, document DE 20 2006 014 923 U1 discloses an operating platform which is arranged in the region of the eyepiece at the housing of the sighting telescope. Therefore, the operating platform has at least two switches which may be operated by the user. Among experts, an operating platform of this kind is also referred to as cockpit.

Document CN101017239A discloses a sighting telescope having a detachable cockpit having two control buttons which may be accessed from the outside. The cockpit has a very restricted functionality and cannot meet the requirement of high flexibility.

Catalogue “Optisan® Japan's Secret Optics—Mamba series; The Pro-Hunter's choice—Low profile for high performance”, Optc-015, April 2008, and the corresponding user's manual “User Manual—MTC Mamaba” (www.mtcoptics.co.uk) discloses a sighting telescope having a detachable cockpit having two operating buttons. The functionality of the cockpit is very restricted. Functionalities of the cockpit or of the sighting telescope cannot be changed.

Even if these solutions provide advantages in connection with ergonomics and the operation by user, the lack of functionality of the far-optical device has nevertheless to be considered as disadvantageous. This lacking functionality results from the fact that the functionalities of the far-optical device cannot be changed or adjusted to individual requirements. There is however frequently the need for equipping an existing device with new functionalities or to modify existing functions individually. There is furthermore the problem that in the event that one functionality fails due to a defective component, the entire far-optical device must be sent in for repair. As a consequence, the device is not available to the user during the term of repair, although the device could be used with restricted functionality.

It is thus the objective of the invention to propose a far-optical device such as a telescope, a sight or a sighting telescope, by means of which functionalities of the far-optical device may simply be changed, restored and/or extended. The far-optical device needs to be characterized by a high level of user-friendliness and preferably provides the user with the possibility to modify existing functions by himself/herself and/or to extend the far-optical device by new functionalities.

This objective is achieved by a far-optical device of the above-mentioned kind having characteristics of the characterizing part of patent claim 1, according to which the control electronics, in particular when the detachable unit is a in detached state, may be programmed by the user via at least one operating element arranged on the detachable unit. This allows the user to modify or extend the functionalities of the far-optical device without the help of the producer and without the help of external devices. Also in terms of functionality, the detachable unit thus represents an independent unit.

The objective is also achieved by a detachable unit for a far-optical device, in particular a telescope, a sight or a sighting telescope, with the detachable unit being attachable onto the basic body of the far-optical device, characterized in that a control electronics for controlling an electrical load, in particular a reticule illumination, an ambient lighting and/or a measuring device, is integrated in the detachable device, with the control electronics, in particular when the detachable unit is in a detached state, may be programmed by the user via at least one operating element arranged on the detachable unit.

By integrating the control electronics in a unit that may be detached from the basic body, a higher flexibility in terms of usage, maintenance and retrofit of a far-optical device is created. Should a control electronics be defective, it is possible for the detachable unit to be sent in for repair separately, while the far-optical device may still be used with restricted functionality. In the event that the control electronics for reticule illumination of a sighting telescope fails, it is possible for the sighting telescope to be continued to be used for the term of the repair without reticule illumination. The basic body of the far-optical device includes the optics, i.e. the optical components, such as in particular eyepiece, objective and, if applicable, a reversing system.

Another advantage is that it is possible for the control electronics integrated in the detachable unit to be used with not only one but also with other far-optical devices. It would vice versa be possible for different detachable units to be used with one far-optical device. Thus, the dealer could provide the customer with a replacement-unit for the term of the repair.

The control electronics is preferably arranged on a board which is firmly connected to the housing of the detachable unit, with the result that the entire construction is shockproof when shooting. The board, where the control electronics is arranged on, is preferably essentially adjusted to be parallel to the optical axis of the eye-piece. Fastening the board on the wall of the detachable unit facing away from the basic body and/or its arrangement between opposite lateral walls of the detachable unit increase the stability when shooting.

Particular aspects in connection with far-optical devices particularly regard their illumination and/or integration of ballistics, laser-range finding or other electronic functionalities and their integration in the far-optical device.

In a preferred embodiment, at least one operating element which is accessible for the user and cooperates with the control electronics and which is provided for activating or adjusting a function of the far-optical device effected by the electrical load is integrated in the detachable unit. This enables the user to operate the control electronics via an operating element, even if the detachable unit is in a detached state, with the result that the unit may offer functionalities even if it is not connected to the basic body of the far-optical device. This is in particular the case if the user can modify the functionalities contained in the control electronics by means of the operating elements.

The detachable unit preferably comprises at least one data processing device, in particular a microprocessor, preferably integrated in the control electronics. This allows the user to use the control electronics also for performing data operations.

Those may also refer to the performance of the electrical load, but also to a function independent thereof.

In a possible embodiment, the data processing device includes a ballistics computer. The user can enter ballistics-related data via the operating elements and receives, as a function of the data entered by him/her, information with respect to e.g. launch angles, trajectory, angle of entry, etc. The advantage is that the ballistics computer may also be used or programmed when detached.

In a preferred embodiment, the detachable unit comprises at least one data memory preferably integrated in the control electronics. It is thus possible that entered data of the user are stored for later applications and/or are available for being read by a computer.

In another possible embodiment, the detachable unit has at least one data communications interface, which is connected to the control electronics, with preferably the data communications interface being arranged on the side of the detachable unit facing the basic body and being inaccessible in attached state of the detachable unit. This enables the detachable unit to communicate with other media, in particular PCs. It is possible for the data communications interface to be a wireless interface (e.g. Bluetooth, WLAN, etc.) or a tethered interface (e.g. a USB interface). The flexibility of the far-optical device is thus increased. It is furthermore made possible for the user himself/herself to simply adjust functions of the far-optical device in accordance with his/her requirements.

For programming the control electronics, the operating element is in a development arranged on the side of the detachable unit facing in attached state the basic body. The operating elements provided for the programming are inaccessible and due to their arrangement protected against mechanical effects and dirt during the intended use of the far-optical device, e.g. of a sighting telescope during the hunt. It is thus possible that they are embodied to be smaller or less robust than the operating elements that are accessible from the outside when the detachable unit is in an attached state.

The electrical load is preferably a measuring device, in particular a range finder, and a processing unit for evaluating the measurement data generated by the measuring device is integrated in the detachable unit. It is with this embodiment not only possible to control electrical loads, but also to, in the broadest sense, generate, read and evaluate measurement data. For the user, the detachable unit is an interactive tool and it is possible for him/her to act correspondingly and/or correspondingly reprogram the control electronics depending on the evaluated data.

Preferably, an information device, in particular a display, is integrated in the detachable unit, with preferably the information device being disposed on the side of the detachable unit facing the basic body and being covered when the detachable unit is attached. This enables the user to display status information regarding the electrical load, stored data or data processing processes. When disposed on the side facing the basic body, the information device is protected against mechanical effects and dirt.

Preferably, the electrical load is disposed inside the basic body. It is thus possible for the detachable unit to be designed to be spaced-saving, whilst the normally long-living and low-maintenance load, in particular e reticule illumination, is disposed in a protected position.

The detachable unit and the basic body preferably have one respective electrical contact interface, which in the attached state of the detachable unit cooperate electrically conductively, in particular for establishing an electrical connection between the detachable unit and the electrical load. This allows a simple detachable electrical connection between detachable unit and load.

In a development, the contact interface of the basic body has contact feed throughs extending through the wall of the basic body, which contact feed throughs electrically conductively cooperate with correspondingly designed contacts on the side of the detachable unit facing the basic body. This ensures a high degree of impermeability.

In a development, the contact feed throughs project into a mount adjacent to the inner side of the wall of the basic body, which mount seals the interior of the far-optical device towards the outside preferably together with the wall of the basic body. This continues to increase the closeness, since the mount in the position of the contact feed throughs represents an additional separation of the interior or the far-optical device towards the outside.

In a particular development, a preferably flexible board connected to the contact feed throughs runs from the mount to the electrical load. With respect to contact feed throughs, mount and connection line, this is a design on modular basis, which is not only easy to produce, but also reliable and resistant to vibrations.

The detachable unit preferably comprises at least one energy source for supplying the electrical load, with preferably the energy source being accessible from the side of the detachable unit facing the basic body when attached. An exchange of the energy source, in particular a battery, can thus be carried out independent of the basic body, preferably by detaching the detachable unit.

The detachable unit preferably has an integrated accumulator having a charging interface for a charging device, with the charging interface preferably being disposed on the side of the detachable unit facing the basic body and being inaccessible when the detachable unit is attached. This allows a repeated charging of an energy source used, with preferably the charging interface at the bottom side of the detachable unit being protected from dirt.

In a particular preferred embodiment, the detachable unit is arranged in the region of the eyepiece, preferably directly at the eyepiece section of the far-optical device. This enables the user to operate the far-optical device in close proximity to his/her face and thus in natural and ergonomically preferred arm-position. The operating elements are furthermore easy to find when the eye is in contact with the eyepiece. Another advantage is that the optical setting possibility of the eyepiece, e.g. by an adjustment screw running circumferentially thereon, and the operation of an electrical load are spatially concentrated due to the arrangement at the eye-piece.

The detachable unit preferably has at least two operating elements being disposed opposite each other and spaced apart from each other in the direction perpendicular with respect to the optical axis of the eyepiece. An operation by thumb and trigger finger at the same time is thus essentially eased.

In the state attached to the basic body, the detachable unit is preferably inserted into a fastening structure formed by the basic body and has there a relatively unchangeable position with respect to the basic body. The detachable unit is thus fixed at the far-optical device in a stationary manner and cannot be displaced or fall off, e.g. as a result of effects of a bullet fired from a weapon.

In a preferred embodiment, the detachable unit is fixed to the basic body by a detachable locking mechanism, preferably a snap-mechanism, with the result that a reliably fixation at the basic body is ensured.

In a development, the detachable unit has an unlocking element which may be accessed from the outside, such as a press button, for unlocking the locking mechanism. It is thus easy for the user to detach the unit.

Preferably, the detachable unit is inserted between two retaining element projecting from the basic body and being spaced apart from each other in the direction of the optical axis of the eyepiece. This guarantees a particularly reliable fixation which is resistant to forces acting along the optical axis, in particular in the event of a recoil after a shoot has been fired from the weapon.

In a development, one of the retaining elements is embodied to have the shape of a lug and the other retaining element has at least one preferably conically designed fastening pin projecting in the direction of the detachable unit, which fastening pin mechanically cooperates with the detachable unit. It is possible for the lug to be embodied to be narrow and thus space-saving, whilst the fastening pins in a locked state provide for an additional bracing, what is well-proven in particular for heavy impact forces.

The housing of the detachable unit is preferably connected to the basic body via a sealing which seals the region between the basic body and the detachable unit towards outside. This measure protects the region between the detachable unit and the basic body and thus the functional elements arranged on the bottom side of the detachable unit such as operating elements, information device, interfaces, etc.

In a development, the sealing is embodied in the form of an elastic overcoat, preferably of a rubber overcoat, on the side of the housing of the detachable unit facing the basic body. The detachable unit takes thus the function of a sealing. A sealing as a separate part that may be lost easily is thus not required.

The housing of the detachable unit is preferably made of a plastic material; a solution that is characterized by its particularly low weight.

Following, further advantages of the embodiment and their embodiments will be described:

A problem of the currently produced operating units, also referred to as cockpits, is that there is not more space for operating elements or a larger battery. In terms of milling, it is not possible to hollow more volume out of the existing material without producing wholes at the outer face of the cockpit which would have to be closed or would interfere with the design itself.

For accommodating diverse information, operating and interface elements, it is readily possible to provide the bottom side of the detachable unit, which is not a primary visible face, with several technical recesses that do not interfere with the design and the exterior visible face of the device. The area thus created provides space for accommodating technically useful functionalities without adversely affecting the appearance of the sighting telescope.

It is also possible to provide several, larger or differently shaped access wholes into the interior of the detachable unit here, which would not be possible with e.g. a milled part of all-aluminum, as it would be impossible to produce them in terms of manufacturing. Consequently, the newly invented solution offers many technical freedoms.

In the event that the illumination unit becomes defective at the customer's, the latter is not furthermore required to dismount the entire far-optical device from the weapon send it in for repair. It is possible to let the basic body of the far-optical device on the weapon and continue hunting without control electronics (and e.g. without reticule illumination, only with an included, functionless cover) meanwhile.

Repairing the detachable unit will be faster and more inexpensive, as it is not necessary to carry out elaborate dismounting from weapon or basic body.

It is for e.g. a “Heavy Hunter Upgrade” possible to update only the detachable unit. It is thus possible to incorporate new illumination features or other features more quickly without converting the concept of the entire sighting telescope.

If a user finds the detachable unit in the form of a cockpit too large, it is possible to detach it if not required and to use the far-optical device only with a low or flat protective cover.

It is possible for the detachable unit to be upgraded with very different additional features, it is also imaginable that an additional detachable unit will be offered as a consequence.

Additional functionalities would be e.g. displaying/correcting the correction of ballistics, if applicable by means of a display, preferably an attachable laser range finder, longer durability of illumination by integrated accumulator or operating elements arranged in any order. It is also possible to use these concepts in further projects, e.g. as space for programming elements (entering ballistics data); operating elements disappear inside the joint face towards the detachable unit and are therefore protected if not required; space for larger batteries; as detachable unit that may be connected to a computer in order to, if required, directly transfer data from a ballistics program to the far-optical device; additional electronic features.

The detachable unit would be able to solve the problem of external sealing by generally not sealing those parts that are not relevant for function (e.g. the edge region where the detachable unit and the eyepiece portion overlap due to reasons that are more or less relevant for design). It would be possible to additionally glue a sealing coating onto the detachable unit here.

Further possibilities result from the modular design, because e.g. the reticule illumination could be sold as an accessory, with the energy source being disposed inside the detachable unit.

Another possibility is to realize a fading in of the range of fire via the detachable unit or that the shooting person can enter the fire range via this unit or operating elements below.

The invention will be described in more detail below with reference to the examples of embodiments illustrated in the drawings.

The simplified, schematic drawings illustrate the following:

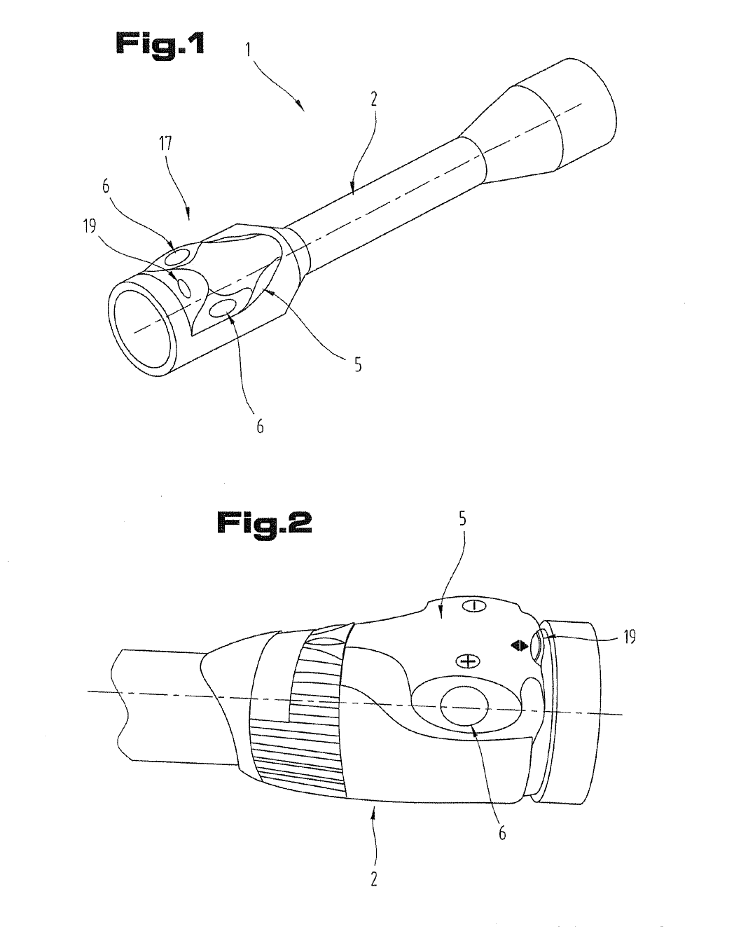

FIG. 1 a far-optical device in the form of a sighting telescope having a detachable unit;

FIG. 2 the eyepiece portion of a far-optical device having a detachable unit;

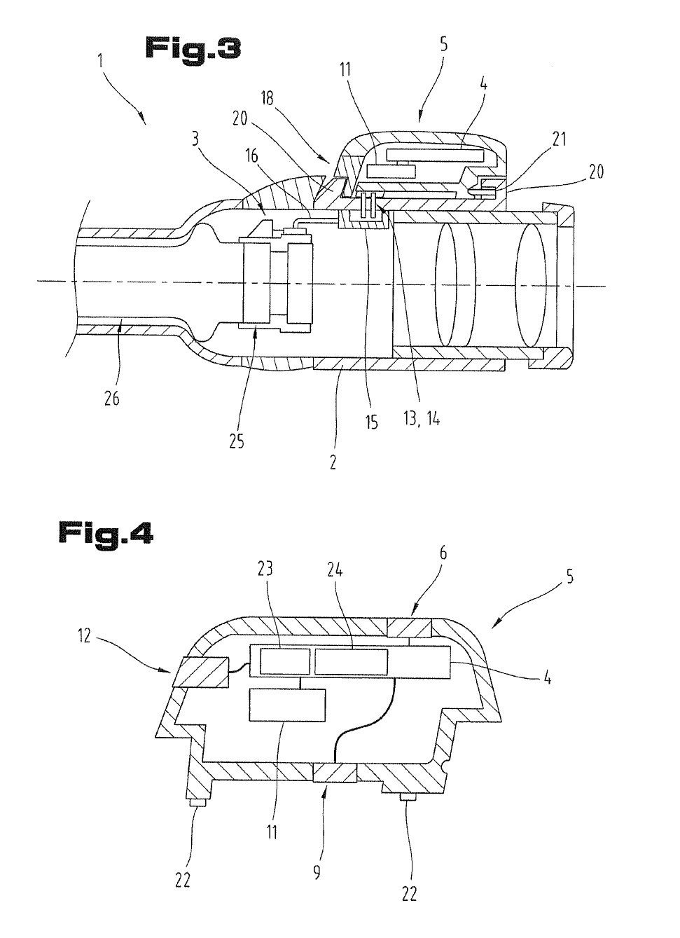

FIG. 3 a section through the eyepiece portion of a far-optical device according to the invention parallel to the optical axis of the eyepiece;

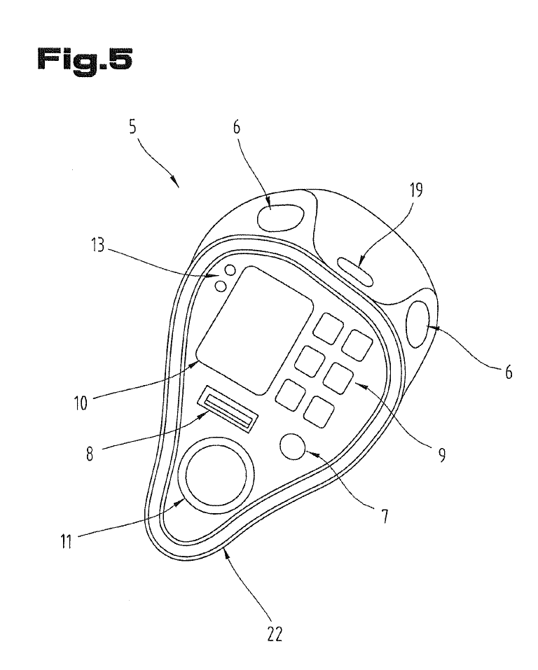

FIG. 4 one section of an embodiment of a detachable unit in detached state;

FIG. 5 the bottom side of a detachable unit.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc., relate to the drawing specifically being described and can be transposed in terms of meaning to a new position when another position is being described. Individual features or combinations of features from the different embodiments illustrated and described may be construed as independent inventive solutions or solutions proposed by the invention in their own right.

FIG. 1 shows a far-optical device 1 in the form of a sighting telescope having a basic body 2. A unit 5 which may be detached from the basic body 2 and has operating elements 6 and an unlocking element 19 in the form of a press button for disconnecting the detachable unit 5 from the basic body 2 is arranged at the eye-piece portion 17. In the embodiment shown, two operating elements 6 being arranged opposite each other and spaced apart from each other in direction perpendicular with respect to the optical axis of the eyepiece are provided.

FIG. 2 shows the eyepiece section 17 of a far-optical device 1 according to the invention in detail, with the detachable unit 5 of FIG. 1, with the detachable unit 5 only differing from FIG. 1 due to its ergonomic design.

FIG. 3 shows the eyepiece portion 17 of a far-optical device 1 having an attached detachable unit 5 in a section parallel to the optical axis of the eyepiece. The eye-piece is held by the basic body 2. Behind the eyepiece, a reticule 25 and a reversing system 26 can be seen. Above the reticule 25, a reticule illumination 3 is disposed, the light of which is led to the reticule 25 via a reflecting-in unit. The reticule illumination 3 is connected to a contact interface 14 below the detachable unit 5 via a flexible board 16. This being the case, the board 16 is wrapped around the reticule mount holding the reticule 25. The contact interface 14 of the basic body 2 is in the attached state of the detachable unit 5 electrically conductively connected to the contact interface 13 of the detachable unit.

The contact interface 14 of the basic body 2 has contact feed throughs in the form of contact pins extending through the wall of the basic body 2, which contact feed throughs project into a mount 15 adjacent to the interior wall of the basic body 2, which mount seals the interior of the detachable unit 5 towards the outside together with the wall of the basic body 2 and thus, the reduced impermeability of the wall caused by the contact feed throughs is compensated. In the exemplary embodiment shown, one end of the board 16 is fastened to the reflecting-in unit and the other end is fixed in the mount 15. In the middle of the mount 15, there are two upwardly directing apertures in the basic body 2, through which apertures the contact pins fixed to the board 16 are led upwardly. The mount 15 and the basic body 2 form an impermeable unity, sealing the apertures toward the outside with respect to the interior of the far-optical device 1. If the unit 5 is detached, the far-optical device 1 continues being an impermeable system.

At the eyepiece portion 17, the basic body 2 has a fastening structure fixing the detachable unit 5 in its attached state in a stationary position relative to the basic body 2. In the embodiment shown, the fastening structure comprises two retaining elements 20 protruding from the basic body 2 and spaced apart from each other in direction of the optical axis of the eyepiece, between which retaining elements the detachable unit 5 is inserted sturdily and shockproof when shooting.

The left retaining element 20 (at the front side of the unit 5) is formed in the shape of a narrow lug and the right retaining element 20 (at the rear side of the unit 5) has one or several fastening pins 21, projecting in direction of the detachable unit 5, preferably being embodied to be conically, which fastening pin mechanically cooperates with the detachable unit 5 in the region of its rear side and holds the latter. The fastening pin 21 is disposed in the basic body 2 or in its fastening structure. The fastening pin 21 extends perpendicularly to the direction the detachable unit 5 is detached (in the example shown in upward direction). The detachable unit 5 is placed between the lug and the fastening pins 21 in a shockproof manner when shooting.

Cooperating with this fastening structure, a detachable locking mechanism 18, e.g. a snap-mechanism or a clip-mechanism, provided at the front side of the detachable unit 5, by means of which the detachable unit 5 may be detachably fastened to the basic body 2. For detaching the locking mechanism 18, the above-mentioned, unlocking element 19 accessible from the outside is used, that e.g. pulls out a spring-loaded or springy bolt out of its locking position.

A control electronics 4 for controlling an electrical load of the far-optical device 1 is integrated in the detachable unit 5 and can thus also be detached from the basic body 2 together with the latter. In the embodiment shown, the unit 5 further includes a source of energy 11. The control electronics 4 is preferably disposed on a board which is built into the unit and communicates with one or several operating elements. It is possible that one or several sources of energy 11, in particular batteries, are disposed on the board, which are preferably accessible from the bottom side when the unit 5 is detached.

FIG. 4 shows an embodiment of the detachable unit 5 having an operating element 6 for activating or setting a function of the far-optical device 1 caused by the electrical load, which operating element is in attached state accessible for the user from the outside and cooperates with a control electronics 4. As it is the case in the embodiment shown, it is possible that this is the activation and brightness control of the reticule illumination 3. The detachable unit 5 further comprises at its bottom side an operating element 9—in a detached state, this is the side facing the basic body 2.

The control electronics 4 comprises a data processing device 24, in particular a microprocessor, and a data memory 23. It is possible for the data processing device 24 and the data memory 23 to be also provided additionally to or separately from the control electronics 4. The data processing device 24 can e.g. include a ballistics computer, by means of which the user can retrieve information on the basis of entered data with respect to trajectory, angle of entry, etc.

As electrical load, the embodiment illustrated in FIG. 4 comprises a measuring device 12 that may particularly be a laser range finder.

Unlike the reticule illumination in FIG. 3, the measuring device 12 is integrated in the detachable unit 5. It is naturally also possible to arrange the measuring devices at or inside the basic body 2 and only to electrically connect it to the detachable unit 5. Preferably, a processing unit for evaluating the data generated by the measuring device 12 is provided in the detachable unit 5, and the evaluating function can also be carried out by the data processing unit 24.

In FIG. 4, also a sealing 22 can be seen, which is fastened to the bottom side of the detachable unit 5 and sits at the basic body 2 in a sealing way when attached. This being the case, the sealing 22 is embodied in the form of an elastic overcoat, preferably of a rubber overcoat, on the detachable unit 5.

FIG. 5 shows the bottom side, i.e. the side facing the basic body 2, of a preferably detachable unit 5. At the latter, there is an information device 10 in the form of a display, operating elements 9 for programming the control electronics 4 or the data processing device 24, an energy source 11 in the form of a battery or an accumulator, a data communications interface 8, a charging interface 7 for charging the energy source 11 and a contact interface 13 for electrically connecting the control unit 4 to an electrical load disposed in or at the basic body 2, such as the abovementioned reticule illumination 3, that are in a position inaccessible when attached and thus protected from mechanical effects and dirt. It is preferably possible for the information device 10 and operating elements 9 to be combined to a touch-screen.

It is possible that also wireless interfaces (wireless transmission, inductive charging) are provided instead of a data communications interface 8, and a charging interface 7 in the form of a plug or a socket.

At the lower edge of the housing of the detachable unit 5, a circumferentially extending sealing 22 can be seen, which—in attached state—rests at the basic body 2 in a sealing way and protects the display and operating elements as well as the interfaces from undesired influences, in particular from moisture and dirt.

If the detachable unit 5 is not available, e.g. due to maintenance or repair work, and it is nevertheless required for the far-optical device 1 to be used with restricted functions, there is the possibility to cover that place, which is otherwise covered by the detachable unit 5, by means of a simple cover, which may also be connected to the basic body 2 in a fixed manner. This being the case, the cover may have a design similar to or even identical with that of the detachable unit 5 and protects the contact interfaces 14. Since it is not required for the cover to have any electrical functions, it is naturally possible to be embodied to be considerably smaller or flatter than the detachable unit 5. It preferably cooperates with the same locking mechanism 18 which is also used for fastening the detachable unit 5.

The embodiments illustrated as examples represent possible variants of the far-optical device 1, and it should be pointed out at this stage that the invention is not specifically limited to the variants specifically illustrated, and instead the individual variants may be used in different combinations with one another and these possible variations lie within the reach of the person skilled in this technical field given the disclosed technical teaching. Accordingly, all conceivable variants which can be obtained by combining individual details of the variants described and illustrated are possible and fall within the scope of the invention.

For the sake of good order, finally, it should be pointed out that, in order to provide a clearer understanding of the design of the far-optical device 1, they and their constituent parts are illustrated to a certain extent out of scale and/or on an enlarged scale and/or on a reduced scale.

The objective underlying the independent inventive solutions may be found in the description.

1. A far-optical device comprising:
a, at least one electrical load and
control electronics for controlling the at least one electrical load,
wherein the control electronics are integrated in a detachable unit which is attached to the body
wherein the control electronics can be programmed by the user when the detachable unit is in a detached state via at least a first operating element disposed in the detachable unit.

2. The far-optical device according to claim 1, wherein at least the first operating element is integrated in the detachable unit and is accessible for the user, and
wherein at least the first operating element cooperates with the control electronics and serves for activating or setting a function of the far-optical device effected by the electrical load.

3. The far-optical device according to claim 1, wherein the detachable unit comprises at least one data processing device preferably integrated in the control electronics, and wherein the at least one data processing device includes microprocessor.

4. The far-optical device according to claim 3, wherein the data processing device includes a ballistics computer.

5. The far-optical device according to claim 1, wherein the detachable unit comprises at least one data memory preferably integrated in the control electronics.

6. The far-optical device according to claim 1, wherein the detachable unit further comprises
has at least one data communications interface configured to connect to the control electronics,
wherein the data communications interface is preferably arranged on the side of the detachable unit facing the basic body thereby being inaccessible when the detachable unit is in an attached state.

7. The far-optical device according to claim 1, further comprising at least a second operating element disposed in the detachable unit,
wherein at least the second operating element is configured to program the control electronics and is arranged on the side of the detachable unit facing in when the detachable unit is in an attached state.

8. The far-optical device according to claim 1, wherein the electrical load is a measuring device, and
the detachable unit further comprises a processing unit for evaluating the data generated by the measuring device.

9. The far-optical device according to claim 1, wherein the detachable unit further comprises
an information device disposed on the side of the detachable unit facing the basic body and being covered when the detachable unit is in an attached state.

10. The far-optical device according to claim 1, wherein the electrical load is arranged inside the basic body.

11. The far-optical device according to claim 1, wherein the detachable unit and the basic body each have a contact interface, which interact electrically when the detachable unit is in an attached state, to establish an electrical connection between the detachable unit and the electrical load.

12. The far-optical device according to claim 1, wherein the detachable unit further comprises at least one energy source for supplying the electrical load, and wherein the at least one energy source is accessible from the side of the detachable unit facing in when the detachable unit is in an attached state.

13. The far-optical device according to claim 12, wherein the at least one energy source is an accumulator, wherein the detachable unit further comprises a charging interface for a charging device, and wherein the charging interface is connected to the accumulator and is arranged on the side of the detachable unit facing the basic body thereby being inaccessible when the detachable unit is in an attached state.

14. The far-optical device according to claim 1, wherein the detachable unit is arranged in an eyepiece region of the far-optical device.

15. The far-optical device according to claim 1, wherein the detachable unit is configured to be inserted in a fastening structure formed from the basic body, wherein the detachable unit is unmovable relative to the basic body when inserted in the fastening structure.

16. The far-optical device according to claim 1, wherein the far-optical device is selected from the group consisting of a telescope, a sight, and a sighting telescope.

17. The far-optical device according to claim 1, wherein the at least one electrical load is selected from the group consisting of a reticule illumination, an ambient illumination, and a measuring device.

18. The far-optical device according to claim 8, wherein the measuring device is a range finder.

19. The far-optical device according to claim 9, wherein the information device is a display.

20. The far-optical device according to claim 14, wherein the detachable unit is arranged directly at the eyepiece portion of the far-optical device.
